(19) United States
(12) Patent Application Publication
(10) Pub. No.: US 2022/0185470 A1
(43) Pub. Date: Jun. 16, 2022

(54) AERIAL ILLUMINATION SYSTEM

(71) Applicant: William D. Johns, Arlington, VA (US)

(72) Inventor: William D. Johns, Arlington, VA (US)

(21) Appl. No.: 17/121,604

(22) Filed: Dec. 14, 2020

(51) Int. Cl. B64C 39/02; B64D 47/02; B64D 47/08; F21V 21/108; H05B 47/105; H05B 47/155; H05B 47/19

(52) U.S. Cl. CPC B64C 39/024; B64D 47/02; B64D 47/08; F21V 21/108; H05B 47/105; H05B 47/155; F21W 2107/30; B64C 2201/027; B64C 2201/108; B64C 2201/127; B64C 2201/12; B64C 2201/146; H05B 47/19

(57) ABSTRACT

An aerial illumination system running a program thereon, the aerial illumination system including at least one illuminating unmanned aerial vehicle, including a main body, and a media unit disposed on at least a portion of the main body to illuminate a target area, and at least one control device connected to the at least one illuminating unmanned aerial vehicle to control operations of the at least one illuminating unmanned aerial vehicle based on the program.

### BACKGROUND

### 1. Field

The present general inventive concept relates generally to an illumination system, and particularly, to an aerial illumination system.

### 2. Description of the Related Art

Illumination has important effects in many facets of life. The application of light is often required for sight in low light and/or dark conditions. However, it also has psychological effects and/or improves an aesthetic of a surrounding area.

Currently, illumination occurs from both natural and/or artificial light sources. Some types of natural illumination are facilitated indoors through the use of mirrors, light shelves, windows, and/or skylights. More specifically, sources of natural illumination occur from sunlight, stars, comets, quarks, and/or other illuminated interstellar objects.

There are many different types of artificial light sources. For example, the types of artificial light sources include a pendant light, a recessed light, a general light, a task light, an accent light, a ceiling mounted fixture, a track light, a spotlight, a wall sconce light, a desk light, a table light, and a cover light. Moreover, the artificial light sources rely on electric lighting and/or gas lighting.

Yet, a common limitation to the artificial light sources is they are fixed (i.e. fixtures) and/or attached to a surface (e.g., table or wall) that is connected to a ground surface. In other words, the artificial light sources have a limited range of movement and/or a limited area of effect that can be illuminated. As such, the artificial light sources leave some surrounding areas dark.

Therefore, there is a need for an artificial light source that illuminates any surrounding area on demand including in the air.

### SUMMARY

The present general inventive concept provides an aerial illumination system.

Additional features and utilities of the present general inventive concept will be set forth in part in the description which follows and, in part, will be obvious from the description, or may be learned by practice of the general inventive concept.

The foregoing and/or other features and utilities of the present general inventive concept may be achieved by providing an aerial illumination system running a program thereon, the aerial illumination system including at least one illuminating unmanned aerial vehicle, including a main body, and a media unit disposed on at least a portion of the main body to illuminate a target area, and at least one control device connected to the at least one illuminating unmanned aerial vehicle to control operations of the at least one illuminating unmanned aerial vehicle based on the program.

The at least one illuminating unmanned aerial vehicle may further include a plurality of booms disposed at a first end on at least a portion of the main body to protrude away from the main body, and a plurality of propellers disposed on at least a portion of a second end of each of the plurality of booms to increase elevation in a first flight setting and decrease elevation in a second flight setting.

The at least one illuminating unmanned aerial vehicle may further include a plurality of boom lights disposed on at least a portion of the second end of each of the plurality of booms to identify activation of the at least one illuminating unmanned aerial vehicle.

The media unit may include a spotlight movably disposed on at least a portion of the main body, a speaker disposed on at least a portion of the main body to perform at least one of emitting at least one sound and receiving at least one external sound therein, and a camera movably disposed on at least a portion of the main body to perform at least one of recording at least one picture and at least one video therein.

The at least one illuminating unmanned aerial vehicle may follow movement of the at least one control device, such that the spotlight illuminates a predetermined distance away from the at least one control device.

The spotlight may adjust a light setting in response to input on the at least one control device, such that the light setting is at least one of a color of the spotlight, a temperature level of the spotlight, and a wavelength of the spotlight.

The spotlight and the speaker may provide a light show with music.

The at least one illuminating unmanned aerial vehicle may cooperate with another at least one illuminating unmanned aerial vehicle to create the light show with music.

The at least one control device may schedule a time of service of the at least one illuminating unmanned aerial vehicle based on the program.

The at least one illuminating unmanned aerial vehicle may use the program to learn operation patterns to perform the schedule based on the at least one illuminating unmanned aerial vehicle performing the schedule repeatedly a predetermined number of times.

The at least one illuminating unmanned aerial vehicle may send a continue query to the at least one control device to determine whether the at least one illuminating unmanned aerial vehicle should continue the schedule based on the operation patterns.

The at least one illuminating unmanned aerial vehicle may automatically schedule a time of service of the at least one illuminating unmanned aerial vehicle.

The at least one illuminating unmanned aerial vehicle may learn operation patterns to perform the schedule based on the at least one illuminating unmanned aerial vehicle performing the schedule repeatedly a predetermined number of times.

The at least one illuminating unmanned aerial vehicle may send a continue query to the at least one control device to determine whether the at least one illuminating unmanned aerial vehicle should continue the schedule based on the operation patterns.

The at least one illuminating unmanned aerial vehicle may move to an emergency location in response to receiving an emergency alert from the at least one control device.

The at least one illuminating unmanned aerial vehicle may depart from a rental business in response to completion of a rental agreement.

The at least one illuminating unmanned aerial vehicle may automatically return to a point of origin in response to detecting a low power level.

The at least one illuminating unmanned aerial vehicle may automatically return to a point of origin in response to detecting a defective operating status.

### BRIEF DESCRIPTION OF THE DRAWINGS

These and/or other features and utilities of the present generally inventive concept will become apparent and more readily appreciated from the following description of the embodiments, taken in conjunction with the accompanying drawings of which:

FIG. 1 illustrates a bottom perspective view of an aerial illumination system, according to an exemplary embodiment of the present general inventive concept; and

FIG. 2 illustrates a side perspective view of the aerial illumination system, according to an exemplary embodiment of the present general inventive concept.

### DETAILED DESCRIPTION

Various example embodiments (a.k.a., exemplary embodiments) will now be described more fully with reference to the accompanying drawings in which some example embodiments are illustrated. In the figures, the thicknesses of lines, layers and/or regions may be exaggerated for clarity.

Accordingly, while example embodiments are capable of various modifications and alternative forms, embodiments thereof are shown by way of example in the figures and will herein be described in detail. It should be understood, however, that there is no intent to limit example embodiments to the particular forms disclosed, but on the contrary, example embodiments are to cover all modifications, equivalents, and alternatives falling within the scope of the disclosure. Like numbers refer to like/similar elements throughout the detailed description.

It is understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art. However, should the present disclosure give a specific meaning to a term deviating from a meaning commonly understood by one of ordinary skill, this meaning is to be taken into account in the specific context this definition is given herein.

### LIST OF COMPONENTS

Aerial Illumination System 100
Illuminating Unmanned Aerial Vehicle 110
Main Body 111
Booms 112
Motors 113
Propellers 114
Boom Lights 115
Landing Gears 116
Landing Light 116a
Mounting Frame 117
Media Unit 118
Spotlight 118a
Speaker 118b
Camera 118c
Control Unit 119
Processing Unit 119a
Communications Unit 119b
Storage Unit 119c
Power Source 119d
Control Device 120
Input Unit 121
Display Unit 122
Processing Unit 123
Communication Unit 124
Storage Unit 125

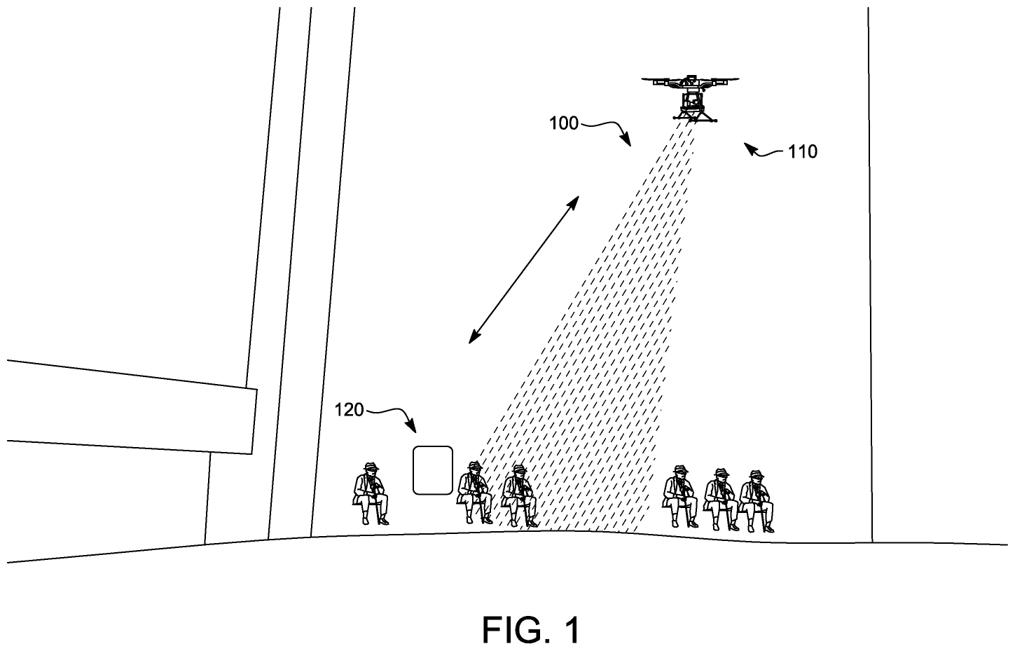

FIG. 1 illustrates a bottom perspective view of an aerial illumination system 100, according to an exemplary embodiment of the present general inventive concept.

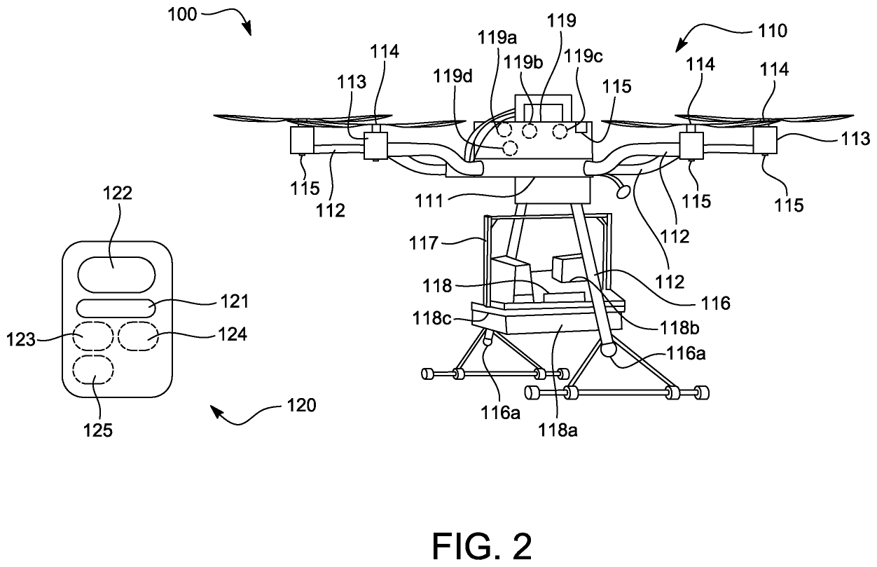

FIG. 2 illustrates a side perspective view of the aerial illumination system 100, according to an exemplary embodiment of the present general inventive concept.

The aerial illumination system 100 may be constructed from at least one of metal, plastic, wood, glass, and rubber, etc., but is not limited thereto.

The aerial illumination system 100 may include at least one illuminating unmanned aerial vehicle (UAV) 110 and at least one control device 120, but is not limited thereto.

The at least one illuminating unmanned aerial vehicle 110 may include a main body 111, a plurality of booms 112, a plurality of motors 113, a plurality of propellers 114, a plurality of boom lights 115, a plurality of landing gears 116, a mounting frame 117, a media unit 118, and a control unit 119, but is not limited thereto.

The main body 111 may have any size (i.e. length, width, height) and shape based on a preference of a user and/or a manufacturer.

The plurality of booms 112 may have any number thereof, such as four booms, six booms, eight booms, and/or ten booms based on the preference of the user and/or the manufacturer. Moreover, the difference in the number of booms changes performance of the at least one illuminating unmanned aerial vehicle 110. For example, the at least one illuminating unmanned aerial vehicle 110 having four booms may provide greater maneuverability of the at least one illuminating unmanned aerial vehicle 110 than the at least one illuminating unmanned aerial vehicle 110 having ten booms. Conversely, the at least one illuminating unmanned aerial vehicle 110 having ten booms may provide greater stability during flight than the at least one illuminating unmanned aerial vehicle 110 having four booms.

The plurality of booms 112 may be disposed at a first end on at least a portion of the main body 111. More specifically, each of the plurality of booms 112 may protrude away from the main body 111 in a different direction from each other. For example, where the at least one illuminating unmanned aerial vehicle 110 has four booms, a first boom of the plurality of booms 112 may protrude away from the main body 111 in a first direction, a second boom of the plurality of booms 112 may protrude away from the main body 111 in a second direction opposite with respect to the first direction, a third boom may protrude away from the main body 111 in a third direction different from the first direction and/or the second direction, and a fourth boom of the plurality of booms 112 may protrude away from the main body 111 in a fourth direction opposite with respect to the third direction. Furthermore, the third boom of the plurality of booms 112 may be disposed between the first boom and/or the second boom, and the fourth boom of the plurality of boom 112 may be disposed between the first boom and/or the second boom.

Each of the plurality of motors 113 may be disposed on at least a portion of a second end of each of the plurality of booms 112. In other words, a number of the plurality of motors 113 may correspond to a number of the plurality of booms 112, which as described above may be four booms, six booms, eight booms, and/or ten booms.

Each of the plurality of propellers 114 may be disposed on at least a portion of the second end of each of the plurality of booms 112 and connected to each of the plurality of motors 113. In other words, a number of the plurality of propellers 114 may correspond to the number of the plurality of booms 112, which as described above may be four booms, six booms, eight booms, and/or ten booms. Additionally, the plurality of propellers 114 may be oriented towards a top of the at least one illuminating unmanned aerial vehicle 110. Moreover, the plurality of propellers 114 may move (i.e. rotate) in response to rotation of the plurality of motors 113. The plurality of propellers 114 may increase in a first flight setting and/or decrease in a second flight setting an elevation of the at least one illuminating unmanned aerial vehicle 110 in response to rotation of the plurality of propellers 114. In other words, the plurality of propellers 114 may facilitate flight of the at least one illuminating unmanned aerial vehicle 110.

Each of the plurality of boom lights 115 may be disposed on at least a portion of the second end of each of the plurality of booms 112. In other words, a number of the plurality of boom lights 115 may correspond to the number of the plurality of booms 112, which as described above may be four booms, six booms, eight booms, and/or ten booms. Additionally, the plurality of boom lights 115 may be oriented towards a bottom of the at least one illuminating unmanned aerial vehicle 110. Moreover, the plurality of boom lights 115 may illuminate a surrounding area of the main body 111. Also, the plurality of boom lights 115 may identify activation of the at least one illuminating unmanned aerial vehicle 110, such that an observer may know a presence of the at least one illuminating unmanned aerial vehicle 110.

Each of the plurality of landing gears 116 may include a landing light 116a, but is not limited thereto.

Each of the plurality of landing gears 116 may also include a rod and at least one wheel, but is not limited thereto.

The plurality of landing gears 116 may be disposed on at least a portion of a bottom of the main body 111. Although the plurality of landing gears 116 is described in plurality, the plurality of landing gears 116 may be a single landing gear 116.

Moreover, the plurality of landing gears 116 may suspend the main body 110 over a surface, such as a ground surface. Also, the plurality of landing gears 116 may absorb a kinetic energy impact to the main body 111 during landing on the surface, such that the plurality of landing gears 116 may prevent damage to the main body 111 during landing.

The landing light 116a may be disposed on at least a portion of each of the plurality of landing gears 116. Moreover, the landing light 116a may illuminate a landing area around the plurality of landing gears 116. As such, the landing light 116a may identify activation of the at least one illuminating unmanned aerial vehicle 110, such that the observer may know the presence of the at least one illuminating unmanned aerial vehicle 110.

The mounting frame 117 may be disposed on at least a portion of the main body 111 and/or the plurality of landing gears 116, such as between the plurality of landing gears 116.

The media unit 118 may include a spotlight 118a, a speaker 118b, and a camera 118c, but is not limited thereto.

The spotlight 118a may include an incandescent bulb, a fluorescent lamp, a neon light, a halogen light, a light emitting diode (LED), an arc light, a gas discharge lamp, and a high intensity discharge lamp, but is not limited thereto. Also, the spotlight 118a may be any high powered light with a predetermined energy rating. For example, the spotlight 118a may have an energy rating of at least one thousand six hundred watts (1600 W). Alternatively, the predetermined energy rating of the spotlight 118a may be less than 1600 W based on the preference of the user and/or the manufacturer, such as one thousand five hundred watts (1500 W), one thousand four hundred watts (1400 W), one thousand three hundred watts (1300 W), etc. Also, the spotlight 118a may use lower energy ratings, but with higher equivalents. For example, the spotlight 118a may use only four hundred watts (400 W), but have an energy equivalent output of 1600 W.

The spotlight 118a may be movably (i.e. rotatably) disposed on at least a portion of the mounting frame 117. Additionally, the spotlight 118a may be oriented toward the surface below the mounting frame 117. However, the spotlight 118a may move three-hundred sixty degrees with respect to the mounting frame 117. In other words, the spotlight 118a may be oriented in any direction.

Therefore, the spotlight 118a may illuminate a target area. For example, the spotlight 118a may illuminate the ground surface around the user in low light and/or dark conditions.

The speaker 118b may include a microphone, but is not limited thereto.

The speaker 118b may be disposed on at least a portion of the mounting frame 117. Moreover, the speaker 118b may emit at least one sound therefrom. For example, the speaker 118b may emit an alarm, a song (i.e., music), a voice, a beep, and/or any other type of sound. Alternatively, and/or in addition thereto, the speaker 118b may receive at least one external sound therein.

The camera 118c may include any type of camera known to one of ordinary skill in the art, including, but not limited to, an action camera, an animation camera, an autofocus camera, a box camera, a camcorder, a camera phone, a compact camera, a dashboard camera (i.e., a Dashcam), a digital camera, a field camera, a FIREWIRE camera, a helmet camera, a high-speed camera, an instant camera, a keychain camera, a live-preview digital camera, a movie camera, an omnidirectional camera, a pinhole camera, a pocket camera, a pocket video camera, a rangefinder camera, a reflex camera, a remote camera, a stereo camera, a still camera, a still video camera, a subminiature camera, a system camera, a thermal imaging camera, a thermographic camera, a traffic camera, a traffic enforcement camera, a twin-lens reflex camera, a video camera, a view camera, a webcam, a WRIGHT camera, a ZENITH camera, a zoom-lens reflex camera.

The camera 118c may be movably (i.e., rotatably) disposed on at least a portion of the mounting frame 117. Additionally, the camera 118c may be oriented toward the surface below the mounting frame 117. However, the camera 118c may move three-hundred sixty degrees with respect to the mounting frame 117. In other words, the camera 118c may be oriented in any direction. Furthermore, the camera 118c may record at least one picture and/or at least one video thereon.

The control unit 119 may include a processing unit 119a, a communications unit 119b, and a storage unit 119c, but is not limited thereto.

The processing unit 119a (or central processing unit, CPU) may include electronic circuitry to carry out instructions of a computer program by performing basic arithmetic, logical, control and input/output (I/O) operations specified by the instructions. The processing unit 119a may include an arithmetic logic unit (ALU) that performs arithmetic and logic operations, processor registers that supply operands to the ALU and store the results of ALU operations, and a control unit that fetches instructions from memory and “executes” them by directing the coordinated operations of the ALU, registers and other components. The processing unit 119a may also include a microprocessor, a microcontroller, and a sensor.

The communication unit 119b may include a device capable of wireless or wired communication between other wireless or wired devices via at least one of Wi-Fi, Wi-Fi Direct, infrared (IR) wireless communication, satellite communication, broadcast radio communication, Microwave radio communication, Bluetooth, Bluetooth Low Energy (BLE), Zigbee, near field communication (NFC), and radio frequency (RF) communication, USB, global positioning system (GPS), Firewire, and Ethernet.

The storage unit 119c may include a random access memory (RAM), a read-only memory (ROM), a hard disk, a flash drive, a database connected to the Internet, cloud-based storage, Internet-based storage, or any other type of storage unit.

The processing unit 119a may access the Internet via the communication unit 119b to allow the user to access a website, and/or may allow a mobile application and/or the software application to be executed using the processing unit 119a. For ease of description, the mobile and/or the software application will be hereinafter referred to as an app. The app may be downloaded from the Internet to be stored on the storage unit 119c. Also, the processing unit 119a, the communication unit 119b, and/or the storage unit 119c may be electrically connected to the plurality of motors 113, the plurality of propellers 114, the plurality of boom lights 115, and/or the media unit 118, such that the processing unit 119a via the app may control operations.

Accordingly, the processing unit 119c may execute the app to control all operations of the at least one illuminating unmanned aerial vehicle 110.

Also, the storage unit 119c may store data thereon such as the at least one sound, the at least one external sound, the at least one picture, and/or the at least one video.

The power source 119d may include a battery and a solar cell, but is not limited thereto.

The power source 119d may provide power to the plurality of motors 113, the plurality of propellers 114, the plurality of boom lights 115, and/or the media unit 118.

The at least one control device 120 may include an input unit 121, a display unit 122, a processing unit 123, a communication unit 124, and a storage unit 125, but is not limited thereto.

The at least one control device 120 may be a radio controller (RC), a mobile device, a mobile phone, a tablet computer, a laptop computer, a personal digital assistant (PDA), and/or a computer of a vehicle, but is not limited thereto and may be any type of electronic device capable of communication with the at least one illuminating unmanned aerial vehicle 110.

The input unit 121 may include a keyboard, a touchpad, a mouse, a trackball, a stylus, a voice recognition unit, a visual data reader, a camera, a wireless device reader, a fingerprint reader, an iris scanner, a facial recognition unit, and a holographic input unit.

The display unit 122 may include a plasma screen, an LCD screen, a light emitting diode (LED) screen, an organic LED (OLED) screen, a computer monitor, a hologram output unit, a sound outputting unit, or any other type of device that visually or aurally displays data.

Also, the display unit 122 may be combined with the input unit 121 to be a touch-screen.

The processing unit 123 (or central processing unit, CPU) may include electronic circuitry to carry out instructions of a computer program by performing basic arithmetic, logical, control and input/output (I/O) operations specified by the instructions. The processing unit 123 may include an arithmetic logic unit (ALU) that performs arithmetic and logic operations, processor registers that supply operands to the ALU and store the results of ALU operations, and a control unit that fetches instructions from memory and “executes” them by directing the coordinated operations of the ALU, registers and other components. The processing unit 123 may also include a microprocessor and a microcontroller.

The communication unit 124 may include a device capable of wireless or wired communication between other wireless or wired devices via at least one of Wi-Fi, Wi-Fi Direct, infrared (IR) wireless communication, satellite communication, broadcast radio communication, Microwave radio communication, Bluetooth, Bluetooth Low Energy (BLE), Zigbee, near field communication (NFC), and radio frequency (RF) communication, USB, global positioning system (GPS), Firewire, and Ethernet.

The storage unit 125 may include a random access memory (RAM), a read-only memory (ROM), a hard disk, a flash drive, a database connected to the Internet, cloud-based storage, Internet-based storage, or any other type of storage unit.

The at least one control device 120 may access the Internet via the communication unit 124 to allow the user to access a website, and/or may allow the app to be executed using the processing unit 123. The app may be downloaded from the Internet to be stored on the storage unit 125. In other words, the software application stored on the storage unit 119c of the at least one illuminating unmanned aerial vehicle 110 may be the same as the app stored on the storage unit 125 of the at least one control device 120.

The at least one control device 120 may use the app via the input unit 121 and/or the communication unit 124 to allow the user to control the at least one illuminating unmanned aerial vehicle 110. The at least one illuminating unmanned aerial vehicle 110 may depart from a point of origin (e.g., a launch pad, a charging station, a building, and/or a home) in response to a request for service from the processing unit 123 of the at least one control device 120 using the app. Moreover, the processing unit 123 may execute the app in response to receiving a tracking command from the input unit 121 to identify a geographical position of the at least one illuminating unmanned aerial vehicle 110 using GPS of the communication unit 119b.

Furthermore, the processing unit 123 executing the app may send at least one command over the communication unit 124 to the communication unit 119b, such that the processing unit 119a may execute the at least one command. For example, the processing unit 123 may execute the app in response to receiving an input on the input unit 121 to illuminate the spotlight 118a, emit the at least one sound from the speaker 118b, record the at least one external sound on the speaker 118b, record the at least one picture on the camera 118c, record the at least one video on the camera 118c, activate (i.e. turn on) the plurality of propellers 114 and/or the plurality of motors 113, increase and/or decrease rotation speed of the plurality of propellers 114 and/or the plurality of motors 113, increase and/or decrease movement speed of the at least one illuminating unmanned aerial vehicle 110, and/or increase and/or decrease the elevation of the at least one illuminating unmanned aerial vehicle 110 with respect to the ground surface.

Alternatively, the processing unit 119a may execute the app to perform all the aforementioned operations automatically based on configuration settings of the at least one illuminating unmanned aerial vehicle 110.

Also, the processing unit 123 may execute the app in response to receiving the input on the input unit 121 to schedule a time of service of the at least one illuminating unmanned aerial vehicle 110. Alternatively, the processing unit 119a of the at least one illuminating unmanned aerial vehicle 110 may execute the app to automatically schedule the time of service based on predetermined settings. For example, the processing unit 123 may execute the app to display on the display unit 122 a schedule of the time of service, such as a time of day, a day of a week, month, and/or year, such that the at least one illuminating unmanned aerial vehicle 110 may activate based on the schedule of the time of service, such as night time while the user walks home in front of the home and/or to begin service from a predetermined location (e.g., work, bus stop, train stop, sidewalk, buildings, houses, parking lots, streets, roads, and/or pathways), for a predetermined duration (e.g., one hour, two hours, three hours, etc.).

Accordingly, the input unit 121 may receive the input to schedule the time of service of the at least one illuminating unmanned aerial vehicle 110. The processing unit 119a may execute the app to learn operation patterns to perform the schedule based on the at least one illuminating unmanned aerial vehicle 110 performing the schedule repeatedly a predetermined number of times (e.g., 2 times, 5 times, 10 times). However, the processing unit 119a may send a continue query using the communication unit 119b to the communication unit 124, such that the processing unit 123 may display the continue query on the display unit 122 to determine whether the at least one illuminating unmanned aerial vehicle should continue the schedule based on the operation patterns. In other words, the at least one illuminating unmanned aerial vehicle 110 may change the operation patterns in response to a denial to the continue query, and continue the operation patterns in response to an affirmation of the continue query.

The processing unit 119a may execute the app in response to receiving an emergency alert from the processing unit 123 to schedule an emergency service of the at least one illuminating unmanned aerial vehicle 110. For example, the at least one illuminating unmanned aerial vehicle 110 may move to an emergency location (e.g., an accident, a forest) for search and rescue and/or assisting first responders.

The processing unit 123 may execute the app to display on the display unit 122 an agreement for rental and/or purchase of the at least one illuminating unmanned aerial vehicle 110. In case of rental, the at least one illuminating unmanned aerial vehicle 110 may depart from a rental business and/or other third party location to move toward the position of the at least one control device 120. In other words, the at least one illuminating unmanned aerial vehicle 110 may depart from the rental business in response to completion of a rental agreement.

Additionally, the at least one illuminating unmanned aerial vehicle 110 may receive instructions from the processing unit 123 executing the app that requires the at least one illuminating unmanned aerial vehicle 110 to follow the user via the at least one control device 120. As such, the spotlight 118a may illuminate the target area based on light settings, which may be the at least one control device 120 and/or the user, and/or a predetermined distance away from (e.g., in front of, behind, and/or around) the at least one control device 120, such that the user may see surrounding areas in the dark. In other words, the spotlight 118 may at least partially illuminate a circular surrounding area of the user, such that the spotlight 118 may not be on the user and/or the at least one control device 120.

Also, the processing unit 119a may execute the app to adjust the light settings, such as a color of the spotlight 118a, a temperature level of the spotlight 118a (e.g., increase and/or decrease the temperature level), and/or a wavelength of the spotlight 118a in response to the input on the input unit 121. Alternatively, the processing unit 119a may adjust the light settings automatically based on the preference of the user. The processing unit 119a may execute the app to adjust the light settings such as a width of a beam of light from the spotlight 118a from a wide beam to a narrow beam (i.e. a point).

As such, the spotlight 118a may be used to provide a light show to entertain the user. The spotlight 118a may be combined with the speaker 118b to provide the light show with music.

Furthermore, the at least one illuminating unmanned aerial vehicle 110 may cooperate with another at least one illuminating unmanned aerial vehicle 110 to perform any of the aforementioned operations. For example, the at least one illuminating unmanned aerial vehicle 110 and/or the another at least one illuminating unmanned aerial vehicle 110 may create the light show with music and/or follow the at least one control device 120.

Also, the processing unit 119a may execute the app to monitor a power level of the power source 119d. The processing unit 119a may transmit a low power level (e.g., battery is discharged, out of power, and/or nearly fully discharged) via the communication unit 119b to the communication unit 124, such that the at least one illuminating unmanned aerial vehicle 110 may automatically return to the point of origin, such as a charging location. Moreover, the processing unit 119a may execute the app to monitor an operating status of the plurality of motors 113, the plurality of propellers 114, the plurality of boom lights 115, and/or the media unit 118 (i.e. the spotlight 118a is defective, the speaker 118b is defective, and/or the camera 118c is defective). As such, the processing unit 119a may transmit a defective operating status via the communication unit 119b to the communication unit 124, such that the at least one illuminating unmanned aerial vehicle 110 may automatically return to the point of origin for service.

Additionally, the at least one illuminating unmanned aerial vehicle 110 may remain at the point of origin in response to detecting the low power level and/or the defective operating status prior to dispatch.

The at least one illuminating unmanned aerial vehicle 110 may provide limitless services. The processing unit 123 may execute the app in response to receiving the input on the input unit 121 to preprogram a time of service of the at least one illuminating unmanned aerial vehicle 110 based on time, location, and/or holidays. For example, at least one third party (e.g., an individual and/or a company) may use the at least one control device 120 to arrange the at least one illuminating unmanned aerial vehicle 110 to use the spotlight 118a to illuminate a venue and/or an event, such as a wedding, a barbecue, a birthday, a bar mitzvah, a luau, a funeral, a festival, a concert, either indoors and/or outdoors, but is not limited thereto. Moreover, the speaker 118b may emit music during the wedding. Additionally, the processing unit 119a may receive further instructions from the processing unit 123 via the app to use the spotlight 118a to illuminate a couple using the camera 118c to perform facial recognition of the couple and/or any other face of a person programmed within the app. In other words, the app may have saved thereupon a database and/or program that includes certain people that must be “lit” by the spotlight 118a at a certain time, for example. As such, the app may use the camera 118c to recognize a person's face and/or attire (such as a wedding dress), so that the at least one illuminating unmanned aerial vehicle 110 illuminates a bride at her wedding the entire evening, during a specific time period, or for a particular duration. Additionally, the spotlight 118a may be programmed via the input unit 121 and/or automatically using facial recognition to follow a performer to maintain attention on that person, such as a lead singer in a rock band at a rock concert.

The speaker 118b may emit various music based on the input on the input unit 121 and/or automatically change the music based on a type of music identified within the app, such as rock, alternative, pop, classical, oldies, etc. The processing unit 123 may execute the app in response to receiving the input on the input unit 121 to pre-program the time of service of the at least one illuminating unmanned aerial vehicle 110 to include visual (e.g., color changes and/or flashing lights in the spotlight 118a) and/or audio alerts (e.g., beep, alarm, a voice) to notify people of the change, such as during the wedding to move to a new location, arrival of the bride, beginning of a reception, etc. Therefore, the lighting can be changed based on a user's preference, and the lighting can be scheduled to turn on and/or off and/or be a certain color or brightness level (i.e., bright and/or various dimmed levels), based on events happening at a venue and/or an event.

Also, the at least one illuminating unmanned aerial vehicle 110 may record events thereon, such as people and/or locations.

Another use may be in amusement parks. For example, the amusement park may control the at least one control device 120 to schedule the time of service of the at least one illuminating unmanned aerial vehicle 110 to illuminate a walkway to an entrance, an exit, a bathroom, a restaurant, and/or a ride.

Accordingly, the at least one illuminating unmanned aerial vehicle 110 may save money for the user due to having lighting on-demand instead of the artificial lights that are fixed and are constantly on. Specifically, the cost of recharging the at least one illuminating unmanned aerial vehicle 110 is less expensive and requires less expenditure of power than large lights that are continuously plugged in.

Therefore, the aerial illumination system 100 may illuminate any surrounding area during flight. Moreover, the aerial illumination system 100 may provide illumination at any location and is not limited to a fixed position.

The present general inventive concept may include an aerial illumination system 100 running a program thereon, the aerial illumination system 100 including at least one illuminating unmanned aerial vehicle 110, including a main body 111, and a media unit 118 disposed on at least a portion of the main body 111 to illuminate a target area, and at least one control device 120 connected to the at least one illuminating unmanned aerial vehicle 110 to control operations of the at least one illuminating unmanned aerial vehicle 110 based on the program.

The at least one illuminating unmanned aerial vehicle 110 may further include a plurality of booms 112 disposed at a first end on at least a portion of the main body 111 to protrude away from the main body 111, and a plurality of propellers 114 disposed on at least a portion of a second end of each of the plurality of booms 112 to increase elevation in a first flight setting and decrease elevation in a second flight setting.

The at least one illuminating unmanned aerial vehicle 110 may further include a plurality of boom lights 115 disposed on at least a portion of the second end of each of the plurality of booms 112 to identify activation of the at least one illuminating unmanned aerial vehicle 110.

The media unit 118 may include a spotlight 118a movably disposed on at least a portion of the main body 111, a speaker 118b disposed on at least a portion of the main body 111 to perform at least one of emitting at least one sound and receiving at least one external sound therein, and a camera 118c movably disposed on at least a portion of the main body 111 to perform at least one of recording at least one picture and at least one video therein.

The at least one illuminating unmanned aerial vehicle 110 may follow movement of the at least one control device 120, such that the spotlight 118a illuminates a predetermined distance away from the at least one control device 120.

The spotlight 118a may adjust a light setting in response to input on the at least one control device 120, such that the light setting is at least one of a color of the spotlight 118a, a temperature level of the spotlight 118a, and a wavelength of the spotlight 118a.

The spotlight 118a and the speaker 118b may provide a light show with music.

The at least one illuminating unmanned aerial vehicle 110 may cooperate with another at least one illuminating unmanned aerial vehicle 110 to create the light show with music.

The at least one control device 120 may schedule a time of service of the at least one illuminating unmanned aerial vehicle 110 based on the program.

The at least one illuminating unmanned aerial vehicle 110 may use the program to learn operation patterns to perform the schedule based on the at least one illuminating unmanned aerial vehicle 110 performing the schedule repeatedly a predetermined number of times.

The at least one illuminating unmanned aerial vehicle 110 may send a continue query to the at least one control device 120 to determine whether the at least one illuminating unmanned aerial vehicle 110 should continue the schedule based on the operation patterns.

The at least one illuminating unmanned aerial vehicle 110 may automatically schedule a time of service of the at least one illuminating unmanned aerial vehicle 110.

The at least one illuminating unmanned aerial vehicle 110 may learn operation patterns to perform the schedule based on the at least one illuminating unmanned aerial vehicle 110 performing the schedule repeatedly a predetermined number of times.

The at least one illuminating unmanned aerial vehicle 110 may send a continue query to the at least one control device 120 to determine whether the at least one illuminating unmanned aerial vehicle 110 should continue the schedule based on the operation patterns.

The at least one illuminating unmanned aerial vehicle 110 may move to an emergency location in response to receiving an emergency alert from the at least one control device 120.

The at least one illuminating unmanned aerial vehicle 110 may depart from a rental business in response to completion of a rental agreement.

The at least one illuminating unmanned aerial vehicle 110 may automatically return to a point of origin in response to detecting a low power level.

The at least one illuminating unmanned aerial vehicle 110 may automatically return to a point of origin in response to detecting a defective operating status.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

1. An aerial illumination system running a program thereon, the aerial illumination system comprising:
at least one illuminating unmanned aerial vehicle, comprising:
a main body, and
a media unit disposed on at least a portion of the main body to illuminate a target area; and
at least one control device connected to the at least one illuminating unmanned aerial vehicle to control operations of the at least one illuminating unmanned aerial vehicle based on the program.

2. The aerial illumination system of claim 1, wherein the at least one illuminating unmanned aerial vehicle further comprises:
a plurality of booms disposed at a first end on at least a portion of the main body to protrude away from the main body; and
a plurality of propellers disposed on at least a portion of a second end of each of the plurality of booms to increase elevation in a first flight setting and decrease elevation in a second flight setting.

3. The aerial illumination system of claim 2, wherein the at least one illuminating unmanned aerial vehicle further comprises:
a plurality of boom lights disposed on at least a portion of the second end of each of the plurality of booms to identify activation of the at least one illuminating unmanned aerial vehicle.

4. The aerial illumination system of claim 1, wherein the media unit comprises:
a spotlight movably disposed on at least a portion of the main body;
a speaker disposed on at least a portion of the main body to perform at least one of emitting at least one sound and receiving at least one external sound therein; and
a camera movably disposed on at least a portion of the main body to perform at least one of recording at least one picture and at least one video therein.

5. The aerial illumination system of claim 4, wherein the at least one illuminating unmanned aerial vehicle follows movement of the at least one control device, such that the spotlight illuminates a predetermined distance away from the at least one control device.

6. The aerial illumination system of claim 4, wherein the spotlight adjusts a light setting in response to input on the at least one control device, such that the light setting is at least one of a color of the spotlight, a temperature level of the spotlight, and a wavelength of the spotlight.

7. The aerial illumination system of claim 4, wherein the spotlight and the speaker provide a light show with music.

8. The aerial illumination system of claim 7, wherein the at least one illuminating unmanned aerial vehicle cooperates with another at least one illuminating unmanned aerial vehicle to create the light show with music.

9. The aerial illumination system of claim 1, wherein the at least one control device schedules a time of service of the at least one illuminating unmanned aerial vehicle based on the program.

10. The aerial illumination system of claim 9, wherein the at least one illuminating unmanned aerial vehicle uses the program to learn operation patterns to perform the schedule based on the at least one illuminating unmanned aerial vehicle performing the schedule repeatedly a predetermined number of times.

11. The aerial illumination system of claim 10, wherein the at least one illuminating unmanned aerial vehicle sends a continue query to the at least one control device to determine whether the at least one illuminating unmanned aerial vehicle should continue the schedule based on the operation patterns.

12. The aerial illumination system of claim 1, wherein the at least one illuminating unmanned aerial vehicle automatically schedules a time of service of the at least one illuminating unmanned aerial vehicle.

13. The aerial illumination system of claim 12, wherein the at least one illuminating unmanned aerial vehicle learns operation patterns to perform the schedule based on the at least one illuminating unmanned aerial vehicle performing the schedule repeatedly a predetermined number of times.

14. The aerial illumination system of claim 13, wherein the at least one illuminating unmanned aerial vehicle sends a continue query to the at least one control device to determine whether the at least one illuminating unmanned aerial vehicle should continue the schedule based on the operation patterns.

15. The aerial illumination system of claim 1, wherein the at least one illuminating unmanned aerial vehicle moves to an emergency location in response to receiving an emergency alert from the at least one control device.

16. The aerial illumination system of claim 1, wherein the at least one illuminating unmanned aerial vehicle departs from a rental business in response to completion of a rental agreement.

17. The aerial illumination system of claim 1, wherein the at least one illuminating unmanned aerial vehicle automatically returns to a point of origin in response to detecting a low power level.

18. The aerial illumination system of claim 1, wherein the at least one illuminating unmanned aerial vehicle automatically returns to a point of origin in response to detecting a defective operating status.
